(19) United States
(12) Patent Application Publication
(10) Pub. No.: US 2026/0111435 A1
(43) Pub. Date: Apr. 23, 2026

(54) SYSTEMS AND METHODS FOR A TECHNOLOGY ANALYTICS ENVIRONMENT

(71) Applicant: The PNC Financial Services Group, Inc., Pittsburgh, PA (US)

(72) Inventors: Patrick David O'Connor, Rocky River, OH (US); Bobby Melvin Underwood, JR., Shawnee, KS (US); Sujit Ghosh, Tampa, FL (US); Dave E. Blackett, Akron, OH (US); John Frohlich, Brunswick Hills, OH (US); Kelly Irene Drake Winters, Lakewood, OH (US); Steven John Szakacs, Medina, OH (US); Brian Keith Klein, Eastlake, OH (US); Avneet Singh Buttar, Bay Village, OH (US); Krishna Jasti, Pittsburgh, PA (US); John Donald Penberthy, JR., Pittsburgh, PA (US); Glenn Goodrich, Pittsburgh, PA (US)

(73) Assignee: The PNC Financial Services Group, Inc., Pittsburgh, PA (US)

(21) Appl. No.: 19/426,593

(22) Filed: Dec. 19, 2025

Related U.S. Application Data
(63) Continuation of application No. 18/680,385, filed on May 31, 2024.
(60) Provisional application No. 63/615,921, filed on Dec. 29, 2023.

(51) Int. Cl. G06F 16/25; G06F 16/245

(52) U.S. Cl. CPC G06F 16/254; G06F 16/245

(57) ABSTRACT

The disclosed embodiments describe systems and methods for managing a technology analytics environment. The disclosed systems and methods may comprise receiving by at least one processor of at least one server source data from at least one source database. The source data may be imported into a temporary database. The source data may be transmitted from the temporary database to a data warehouse comprising stored data. The stored data in the data warehouse may be updated using at least one new data record from the source data. A query may be received for the updated stored data from a data access platform associated with the data warehouse. Updated stored data may be provided to the data access platform.

### CROSS-REFERENCE TO RELATED APPLICATIONS

The present application claims the benefit of priority of U.S. Provisional Application No. 63/615,921, filed Dec. 29, 2023, the entire contents of which are incorporated herein.

### TECHNICAL FIELD

The present disclosure relates generally to systems and methods for a technology analytics environment. More specifically, the present disclosure relates to aggregating data from a plurality of data sources for use in response to user queries and data analyses.

### BACKGROUND

Organizations are increasingly managing large data sets and large amounts of data. Often, this data is stored across various storage systems, and comes from various sources. Due to this distribution, the data may include different types of information and have varied formats.

Large data sets present difficulties with extracting and querying relevant information, especially when data comes from different data sources. There is a need to analyze and aggregate data in an efficient manner that effectively manages resources across a network. Often, there are restrictions on who can see what data depending on which organization is entitled to different elements or combinations of data. These organizations may wish to maintain security of who accesses data across an organization without sacrificing efficiency. Currently, data management may be done through the use of keys and indexes that may be used to reference where data is located. Such data management is typically dependent on moving the actual data around during processing, including storage and retrieval operations, resulting in a slow inefficient system at a large scale.

There is a need to improve the speed of accessing and using data to meet specific business needs with scalability. There is also a need to ensure that data is protected and stored in ways that are efficient. There are also needs for data models that fuel integration across disparate source systems. This can also assist with managing the risk of having data across multiple platforms. For example, when data is stored across multiple platforms, there may be a risk regarding security with respect to accessing sensitive data or maintaining the integrity of data.

The present solution utilizes systems and methods to dynamically receive a variety of data and manage it across a data integration system in a technology analytics environment.

### SUMMARY

The disclosed embodiments describe systems and methods for managing a technology analytics environment. The disclosed systems and methods may comprise receiving by at least one processor of at least one server source data from at least one source database. The source data may be imported into a temporary database. The source data may be transmitted from the temporary database to a data warehouse comprising stored data. The stored data in the data warehouse may be updated using at least one new data record from the source data. A query may be received for the updated stored data from a data access platform associated with the data warehouse. Updated stored data may be provided to the data access platform.

According to some embodiments, the at least one source database may be a third-party database.

According to some embodiments, validated source data may be generated by validating the source data at the temporary database or the data warehouse.

According to some embodiments, the temporary database and the data warehouse may be operated by the same server.

According to some embodiments, updating the stored data may further comprise generating at least one first hash key representative of each of the at least one new data record.

According to some embodiments, updating the stored data may further comprise generating at least one second hash key representative of at least one predetermined use associated with the at least one data record.

According to some embodiments, the systems and methods may include generating at least one hub table a new occurrence of each of the at least one second hash key.

According to some embodiments, the systems and methods may include generating at least one point-in-time table, the point-in-time table comprising a recorded time of the updated stored data associated with the at least one hub table.

According to some embodiments, a first record of the updated stored data and a second record of the query may be stored in an audit database.

The disclosed embodiments describe systems and methods for operating a technology analytics environment. The disclosed systems and methods may comprise at least one processor of at least one server. Source data may be received at a temporary database from at least one source database. Source data may be transmitted to a data warehouse comprising stored data. Updated data in the data warehouse may be generated by adding at least one data record of the source data to the stored data. At least one first hash key to each of the at least one data record, the at least one first hash key representative of each occurrence of the at least one data record, may be assigned. At least one second hash key to each of the at least one data record, the at least one second hash key representative of at least one predetermined use associated with the at least one data record, may be assigned. At least one hub table comprising a new occurrence of each of the at least one second hash key corresponding to each of the at least one data record may be generated. A query from a data access platform may be received. In response to the query, the updated data using the at least one hub table, the second hash key, and the first hash key, may be accessed. The updated data may be provided to the data access platform.

According to some embodiments, the source data may be stored in a data storage layer separate from the temporary database.

According to some embodiments, the at least one first hash key and the at least one second hash key may be computed before transmitting the source data to the data warehouse.

According to some embodiments, the at least one first hash key and the at least one second hash key may be computed after transmitting the source data to the data warehouse.

According to some embodiments, the systems and methods may include generating at least one hash table comprising the at least one first hash key and the at least one second hash key.

According to some embodiments, the at least one hash table may further comprise at least one time point at which the at least one data record was collected.

According to some embodiments, the at least one second hash key may represent a column or row in the stored data.

According to some embodiments, the at least one second hash key may represent a data type.

According to some embodiments, the systems and methods may include generating at least one link table comprised of two or more second hash keys to establish a link between the two or more second hash keys.

According to some embodiments, the systems and methods may include generating a point in time table comprising at least one first hash key and a recorded time at which the at least one hub table was generated.

According to some embodiments, the systems and methods may include generating a point in time table comprising at least one first hash key and a recorded time at which the at least one hub table was accessed in response to the query.

According to some embodiments, receiving the query may initiate the source data to be received.

The disclosed embodiments describe systems and methods for changing records in a technology analytics environment. The systems and methods may comprise at least one processor of at least one server. A data change request from a data access platform may be received. In response to the change request, stored data in a data warehouse may be accessed, the stored data comprising at least one data record. The at least one data record may be updated with the data change request. At least one hash table with at least one first hash key associated with the at least one data record and at least one second hash key associated with at least one predetermined use may be updated. At least one hub table with at least one hub hash key based on at least one new occurrence of the at least one second hash key may be updated. At least one link table with at least two hub hash keys to establish a link between the two or more of the at least one hub hash keys may be updated.

According to some embodiments, the systems and methods may include updating a point in time table comprising at least one first hash key and a recorded time corresponding to the data change request.

According to some embodiments, the at least one link table may comprise a unique association between two or more of the at least one hub hash keys.

According to some embodiments, the at least one data record with a second change request may be updated using the at least one link table to identify the stored data without updating the at least one hub table and the at least one link table.

The disclosed embodiments describe systems and methods for facilitating data auditing in a technology analytics environment. The disclosed systems and methods may comprise at least one processor of at least one server. Source data from at least one source database may be received by a temporary database. The source data may be validated at the temporary database and outputting a first validation record. The source data may be sent to a data warehouse. The source data may be validated at the data warehouse and outputting a second validation record. The first validation record, the second validation record, and metadata records characterizing the source data may be stored in the audit database. The stored data in the data warehouse may be updated using at least one new data record in the source data. An update record of the updated stored data may be stored in the audit database. A query for the updated stored data may be received from a data access platform. A query record of the query may be stored in the audit database. In response to an audit request, the update record or the query record may be accessed.

According to some embodiments, the metadata may be generated by the at least one source database, the temporary database, or the data warehouse.

According to some embodiments, the audit database may be stored with the temporary database or the data warehouse.

According to some embodiments, the update record may further comprise: updating at least one hash table with at least one first hash key associated with the at least one data record and at least one second hash key associated with at least one predetermined use; updating at least one hub table with at least one hub hash key based on at least one new occurrence of the at least one second hash key; and updating at least one link table with two or more of the at least one hub hash keys to establish a link between the two or more of the at least one hub hash keys.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates a user wanting access to both new and old data quickly, consistent with disclosed embodiments.

FIG. 2 illustrates a user wanting to be able to change data and an auditor wanting to be able to track and audit data, consistent with the disclosed embodiments.

FIG. 3 illustrates an example system environment for a technology analytics environment, consistent with the disclosed embodiments.

FIG. 4 illustrates an example system environment for the architecture of a technology analytics environment, consistent with disclosed embodiments.

FIG. 5 illustrates an example system environment for the integration layer of a technology analytics environment, consistent with disclosed embodiments.

FIG. 6 illustrates an example process for data flow in a technology analytics environment, consistent with disclosed embodiments.

FIG. 7 illustrates an example process of the integration layer and the data access platform in a technology analytics environment, consistent with disclosed embodiments.

FIG. 8A illustrates an example of changing records in a technology analytics environment, consistent with disclosed embodiments.

FIG. 8B illustrates an example of changing tasks in a technology analytics environment, consistent with disclosed embodiments.

FIG. 9 illustrates an exemplary process for updating stored data, consistent with disclosed embodiments.

FIG. 10 illustrates an exemplary process for providing the updated data to the data access platform, consistent with disclosed embodiments.

FIG. 11 illustrates an exemplary process for updating tables, consistent with disclosed embodiments.

FIG. 12 illustrates an exemplary process for maintaining an audit database, consistent with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

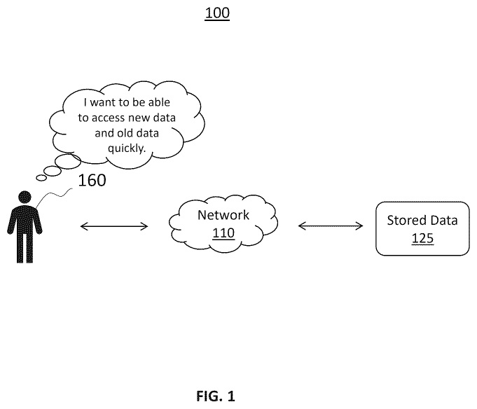

FIG. 1 illustrates a user, such as user 160 wanting access to both new and old data quickly, consistent with disclosed embodiments. User 160 may be any individual enabled to access stored data 125. An exemplary user may include an employee of an organization. For example, user 160 may be a data analyst at a financial institution (e.g. a bank). Old data may be stored data 125. New data may be any data that may be newly added to stored data 125. New data may be similar or different to the old data on stored data 125. User 160 may have access to stored data 125 through network 110. The needs of user 160 may be addressed by any combination of the systems and methods presented herein.

Network 110 may be a collection of interconnected devices that communicate with each other to share data. Network 110 may include the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols.

Stored data 125 may be any data that may be saved and maintained in some form of storage medium. Data may be a storable form of information relating to facts, figures, etc. collected from various sources. Data may include quantities, characters, symbols, raw information, signals, etc. Stored data 125 may be stored on hard drives, solid states drives, databases, etc. A database may refer to an organized collection of information or data (e.g. structure data) stored electronically in a computer system or other storage medium. A database may be a repository for storing, querying, and manipulating data, facilitating data-driven decision-making processes and supporting various applications and services. A database may include tables, records, fields, keys, indexes, relationships, and any data values. A database may be configured to enable efficient data storage, retrieval, and management operations. For example, a database may exist entirely or in part within a cloud-computing system or cloud network and accessed through network 110.

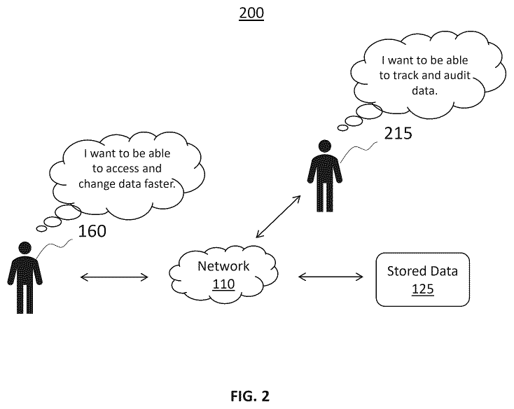

FIG. 2 illustrates user 160 wanting to be able to change data and auditor 215 wanting to be able to track and audit data, consistent with the disclosed embodiments. User 160 and auditor 215 may access stored data 125 through network 110. User 160 may include anyone with access to stored data 125 and anyone who may want to access data or change stored data 125. Auditor 215 may be an individual wanting to perform checks on accuracy, quality, or integrity of data. For example, auditor 215 may be a professional hired by an organization to ensure that data is being managed properly. Because auditor 215 may want to track and audit data, and user 160 may want to access and change data quickly, a system is needed that can improve the efficiency of data access and changes, while maintaining the ability to track all changes for auditor 215. Such a need may be addressed by any combination of the systems and methods presented herein.

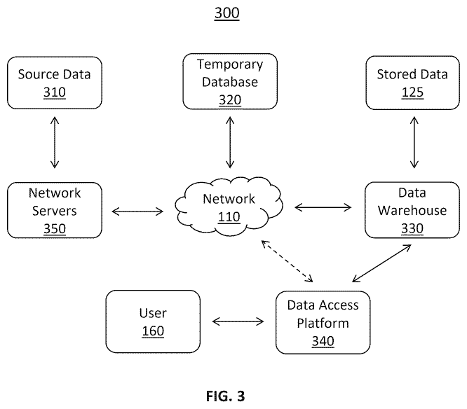

FIG. 3 illustrates an example system environment 300 for a technology analytics environment, consistent with the disclosed embodiments. A technology analytics environment may refer to the infrastructure, processes, tools, and methods that enable acquiring, storing, processing, managing, and visualizing data, or any combination thereof. Data may be transmitted, distributed, accessed, or shared through network 110 between multiple platforms, systems, nodes, servers, or devices. For example, network 110 may connect to network servers 350 housing source data 310. Network 110 may connect temporary database 320, data warehouse 330, or data access platform 340 to one another or to network servers 350. The connections in network 110 may occur in any combination or order. Data access platform 340 may allow user 160 to obtain data associated with data warehouse 330.

Source data 310 may be any data being provided to temporary database 320, data warehouse 330, or data access platform 340. Source data 310 may refer to raw data or the origin or source of the data. Raw data may be unprocessed or unedited data in its original form, thus maintaining the authenticity of source data 310. The origin of the data may be any potential store or repository from a various of sources. In some embodiments, source data 310 may originate from third-party databases. Third-party databases may be any databases not originating at temporary database 320, data warehouse 330, or data access platform 340. For example, a data link database may allow data warehouse 330 to a staging database. For example, source data 310 may originate from service now, archer, eBRP™, Troux™, Clarity™, Calrizen™, HP Application Lifecycle Management (ALM)™, etc.

In some embodiments, source data 310 may be structured. In some other embodiments, source data 310 may be unstructured. Source data 310 may also be any combination of structured and unstructured data. Structured data may be data that is organized and formatted in a predefined manner. For example, structured data may be a table or a spreadsheet, where each data element or entry may be placed into a particular column or row. Unstructured data may be data that does not have a predefined organization or structure. For example, unstructured data may include text documents, images, videos, audio files, emails, sensor data, etc.

A temporary database, such as temporary database 320, may be a database in which data is stored temporarily before reaching a database where the data may be stored, managed, or processed. Temporary may mean that data is stored in temporary database 320 only during processing, and after processing, the data is move out of temporary database 320, and the memory or storage may be cleared for future use. A temporary database may be a data link database, a staging database, a data lake, etc. A data link database may store and provide information or a link of the data to the origin of source data 310. A data link database may also store information that characterizes the data (e.g. metadata, described in further detail below). A staging database may be a temporary storage area used for data processing or prior to data processing. A staging database may collect, clean, transform, or otherwise prepare data before transmitting the data to a target destination such as a data warehouse (e.g. data warehouse 330). While the temporary database may not generally be used to store data, in some cases data may be stored, such as when temporary database may include a data lake. A data lake may be a repository that ingests, stores, and transmits structured or unstructured data. A data lake may be stored on-premises (e.g. Hadoop™ or Apache Spark™), or a data lake may be stored in the cloud (e.g. Amazon S3™, AWS Lake Formation™, Azure Data Lake Storage™, and Google Cloud Storage™).

Data warehouse 330 may be a repository of historical and currently collected data from various sources. Data warehouse 330 may enable efficient analysis, reporting, and decision-making by providing the framework for querying, analyzing, and visualizing data. Data warehouse 330 may include a storage layer for data storage. The storage layer may include tables, indexes, partitions, and other structures commonly used for structured data. Generally, structured data may be processed or transformed into a consistent format following a predefined schema or data model and stored in data warehouse 330 for further use. For example, such further use may include querying and analyses done by individuals in business intelligence. Querying and analyses may include ad-hoc queries, online analytical processing, data mining, and predictive analytics.

Data warehouse 330 may include a data access platform 340. In some embodiments, data access platform 340 may be located separately and configured to interface with data warehouse 330. For example, data access platform 340 may communicate with data warehouse 330 through network 110, or data access platform 340 and data warehouse 330 may operate on different parts of a cloud network or different cloud networks. A cloud network may be any network providing connectivity, security, management services over networks (e.g. network 110). Cloud networks may include infrastructure-as-a-service, platforms-as-a-service, software-as-a-service, etc. Examples of cloud networks may be amazon web services (AWS)™, Microsoft Azure™, and Google Cloud Platform (GCP)™. Data warehouse 330 may include massively parallel processing (MPP) computing systems enabling large-scale data processing by using a plurality of processors or GPUs. MPP may be a coordinated processing by a plurality of processors or GPUs that may work on different parts of a task simultaneously. Data warehouse 330 may include use of traditional data warehouses or cloud data warehouses. Examples of traditional data warehouses (e.g. on-premises) are Teradata™, IBM Db2™, and Oracle Exadata™. Examples of cloud data warehouses are Amazon Redshift™, Google BigQuery™, Snowflake™, and Microsoft Azure Synapse Analytics™. Any of these examples of data warehouses may use MPP.

Data access platform 340 may provide the means for user 160 to interact with and retrieve data stored in a data repository (e.g. data warehouse). Data access platform 340 may use various tools and capabilities to access, search, find, analyze, and visualize data. For example, user 160 may use data access platform 340 to obtain data to make business insights for business development. Data access platform 340 may have interfacing tools such as a graphical user interface (GUI) for user 160 to engage with and input information. User 160 may be able to input information including text, numbers, selections, structured query language (SQL) statements, and the like to search for data. Business intelligence tools may be integrated into data access platform 340. These tools may be used to help with business needs and may include reports, dashboards, and data visualizations using data from data warehouse 330. Data visualization may include charts, graphs, heatmaps, and other visualization. Business intelligence tools may include platforms like Tableau™, Power BI™, QlikView™, and Looker™.

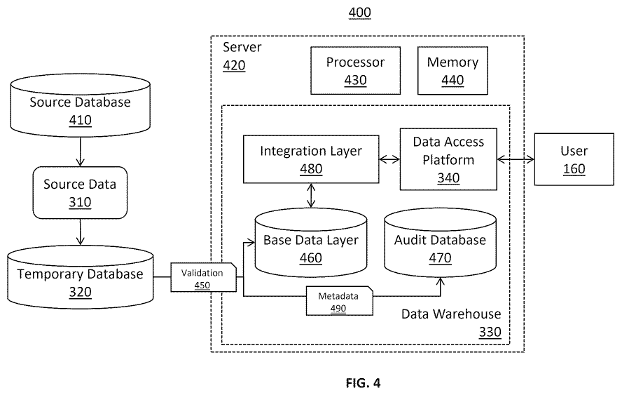

FIG. 4 illustrates an example system environment 400 for the architecture of a technology analytics environment, consistent with disclosed embodiments. Source data 310 may be derived from source database 410. Source databases such as source database 410 may be the original databases from which data may be extracted for various purposes such as data integration, analysis, or reporting. Source databases may contain the raw (e.g. unprocessed) data that may be moved, transformed, or utilized elsewhere (e.g. data warehouse 330). Source data may be stored or pass through temporary database 320 before being transmitted to data warehouse 330 operated by server 420. In some embodiments, server 420 may be configured to operate processor 430 and memory 440. Source data 310 may undergo validation 450 before being processed and stored in base data layer 460 and audit database 470. Temporary database 320 or data warehouse 330 may generate metadata 490 for storage in audit database 470. Integration layer 480 may be involved in processing data to be stored in and accessed from base data layer 460. Integration layer 480 may be involved in processing input from user 160 through data access platform 340. Integration layer 480 may also be used to increase efficiency or accessibility of stored data 125 provided to user 160 through data access platform 340. It is to be understood that FIG. 4 is exemplary and system environment 400 may include more than one of any illustrated component.

Server 420 may be a computer or a system that provides resources, data, services, or functionality to other computers, devices, or users within a network (e.g. network 110). Processor 430 may include various types of processing devices. For example, processor 430 may include a microprocessor, preprocessors (such as an image preprocessor), a graphics processing unit (GPU), a central processing unit (CPU), support circuits, digital signal processors, integrated circuits, processor memory, or any other types of devices suitable for running applications and for image processing and analysis. In some embodiments, processor 430 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures. Memory 440 may be a non-transitory memory, such as a flash memory, a random-access memory (RAM), etc. Memory 440 may be configured to store data, such as computer codes or instructions executable by processor 430. The disclosed embodiments are not limited to any particular configuration of memory 440.

Integration layer 480 may be a data layer that allows data or references to data to be transmitted between various heterogeneous databases, platforms, or data processing systems. Integration layer 480 may include data transforming tools which enable the transformation of data from one format or structure to another. Data mapping may also be a part of integration layer 480. Data mapping may include creating a relationship between data fields, databases, or systems to enable source data 310 to be accurately transformed or referenced to maintain data consistency, quality, and integrity when sought by user 160. In some embodiments, data mapping may be done to allow user 160 to access data without moving data from base data layer 460 in integration layer 480. Data mapping using references that point to data, desired by user 160, in base data layer 460 may improve efficiency and performance of data access platform 340.

Server 420 may operate to receive data or initiate receiving data from various sources using processor 430 and memory 440. In some embodiments, source data 310 may be received from source database 410. Receiving source data 310 may occur over various networks (e.g. network 110). Source database 410 may provide data using various means, such as relational databases, enterprise resource planning (ERP) systems, customer relationship management (CRM) system, flat files (e.g. CSV, Excel™), application programming interface (API), streaming data sources, etc. To access source database 410, connection may be made through network 110 between temporary database 320 or server 420. The connection may be made through various means, including database management systems (e.g. MySQL™, Oracle™, SQL Server™, or MongoDB™), application programming interfaces (APIs), or data integration tools (e.g. Talend™, Informatica™, Microsoft SQL Server Integration Services (SSIS)™, Apache NiFi™). An API may be an interface between two or more programs, software applications, or computer systems. APIs may include a set of rules, protocols, or tools that allow different software applications using different languages to communicate and interact with one another.

In some embodiments, source data 310 may be imported into temporary database 320. Importing source data 310 may include using cloud services or data integration platforms such as MuleSoft™, Dell Boomi™, Informatica Intelligent Cloud Services™, etc. Source data 310 may first be extracted from source database 410. Extracting source data 310 may include use of data integration tools. Custom scripts may also be used as tools for importing data, and may be written in programming languages such as Python, Java, SQL, etc. Temporary database 320 may include a data lake for storage, providing a history of imported data, or for data retention or analytics.

In some embodiments, source data 310 may be transmitted from temporary database 320 to data warehouse 330. Data warehouse 330 may include stored data 125. Data warehouse 330 may be operated by server 420. Source data 310 may be transmitted through network 110. In some embodiments, the temporary database and the data warehouse may be operated by the same server (e.g. overlapping servers of server 420). In some other embodiments, the source data may be stored in a data storage layer separate from the temporary database. A storage layer may be where data is physically stored. Stored data 125 may refer to any data imported from temporary database 320 and stored in a storage layer like base data layer 460. Base data layer 460 may be a layer that serves as a foundation for the data in data warehouse 330. Base data layer 460 may store raw data from source data 310. The raw data may be stored as base tables and keyed or indexed to serve as a reference or identification of the raw data. Keyed data may use a key (e.g. a code or alphanumeric string) to uniquely identify and access the data. An index may be a list or table of keys used to easily look up where the data is located (e.g. storage location in stored data 125). Base tables may have a defined schema that specifies the structure of the data, including columns, data types (e.g. integer, varchar, date, etc.), and other details. For example, a base table may have columns that represent fields of the data, rows that represent individual records or entries of the data, a key for each row/record, and indexes that identify the location or path to the raw data.

In some embodiments, audit database 470 may be stored with temporary database 320 or data warehouse 330. Audit database 470 may be a database used to store and manage logs, track changes to data, user 160 activity with data access platform 340, and other activities to ensure compliance. Compliance may be adhering to legal or regulatory requirements, or to quality control within server 420. Audit database 470 may be read-only, such that editing or deletion of data is not allowed. For example, some or all data in audit database 470 may be associated with or regulated by access permissions. Access permissions may refer to rules or settings that determine who can view, modify, or manage data or resources.

In some embodiments, validated source data may be generated by validating source data 310 at temporary database 320 or data warehouse 330. Validating source data 310 may occur at validation 450. Validation 450 may refer to checking the accuracy, completeness, or consistency of data when importing or transmitting data. Validation 450 may involve checking for data integrity, format validation, or cross-referencing against known standards or reference data. Data integrity may refer to an accuracy or consistency of the data with its original source or form.

Format validation (e.g. for validation 450) may be a check that data is in a particular form or pattern. Such validation may include data type validation, syntax validation, length validation, pattern matching, conditional validation, etc. Data type validation may be a validation process for ensuring that a data type conforms with expectations. Data type may include integers, floats, strings, dates, etc. Syntax validation may be a process of ensuring that data follows rules or structure required by a programming language or data format (e.g. type). Length validation may be a process that ensures data meets prespecified length requirements (e.g. a specific number of characters). Pattern matching validation may be a process to verify that data follows a specific pattern. For example, regular expressions may be used match an expected pattern in data. In another example, common patterns may be used, such as commonly repeated patterns like may be found in email addresses, phone numbers, dates, postal codes, etc.

In some embodiments, source data 310 may be validated at temporary database 320. A validation record associated with temporary database 320 may be produced. A validation record may be a documented record or log that captures the results of validation 450. A validation record may include any data entries found in error. In some embodiments, a data entry may not pass validation, and temporary database 320 may flag the data entry for repeated importing from source database 410. For example, a validation record may include an index of the data entry.

In some embodiments, source data 310 may be validated at data warehouse 330. A validation record associated with data warehouse 330 may be produced. A validation record may be produced for data stored in base data layer 460. For example, a validation record may include reference of which data entry was in error if any and the indexes of the data entry in base data layer 460. For any data found to be in error through validation, importing may be repeated. An error may be a corruption of the data. Corrupted data may be data that has changed form or otherwise made less readable or unreadable due to an error during writing, reading, storage, transmission, or processing of the data. For example, if a corruption in the validated data is found, server 420 may request that temporary database 320 re-acquire source data 310, after which source data 310 may be validated again (e.g. through validation 450).

In some embodiments, stored data 125 in data warehouse 330 may be updated using at least one new data record from source data 310. A data record may be a representation of a set of data elements that are related to one another. A data record may occur in a database, spreadsheet, table, etc. For example, a data record may be a row in a table, where columns represent different data types such as date, time, name, etc. A new data record may be any data record for which there is no currently existing data record in temporary database 320 or base data layer 460. For example, there may be no base table found for the new data record. In such an event, the new data record(s) may be processed and stored appropriately in base data layer 460.

In some embodiments, the validation records associated with temporary database 320 and data warehouse 330, and metadata records characterizing source data 310 may be stored in audit database 470. Metadata records may refer to any record or log of metadata 490 related to source data 310 or source database 410. Metadata 490 may be data that provides information about other data. Metadata 490 may describe various aspects of the data, such as data structure, content, context, and characteristics, to facilitate understanding, management, and use of the data. In some embodiments, metadata 490 may be generated by source database 410, temporary database 320, or data warehouse 330. Such metadata may be used to review aspects of the data without having to transfer the data itself.

In some embodiments, a query may be received from data access platform 340. A query may be provided by user 160. A query may be a request or command to retrieve, manipulate, or perform operations on stored data 125. In some embodiments, receiving a query for the updated stored data from data access platform 340 may be associated with data warehouse 330. For example, a query may be used to provide data for user 160 and data access platform 340 is provided with the data stored in base data layer 460. In some embodiments, receiving the query may initiate source data 310 to be received. For example, source data 310 may be received by temporary database 320 upon a request or command from user 160. User 160 may also set up queries to be automatically received for initiating the receipt of source data 310. For example, user 160 may set up a specified time or intervals of time in which source data 310 should be received. Additionally, server 420 may automatically initiate receipt of source data 310 at regular intervals of time without any query.

In some embodiments a query record of the query may be stored in audit database 470. A query record may be a record or log of queries performed historically or currently from user 160 or other users.

In some embodiments, a data change request may be received from data access platform 340. A data change request may be a particular query, request, or command from user 160 to modify at least one data entry. In some embodiments, in response to the data change request, stored data 125 in data warehouse 330 may be accessed. Stored data 125 may include at least one data record. For example, a data change request may be to change records, change tasks (e.g. for various users), or change approvers for who has control of data access.

In some embodiments, at least one data record may be updated with the data change request. Updating the data record(s) may involve adding or modifying at least one data entry or base table in base data layer 460. In some embodiments, the updated stored data may be provided to data access platform 340. For example, if user 160 requests particular data from data warehouse 330, that data may be provided by integration layer 480 to data access platform 340 for visualization. Visualization may occur on a graphical user interface (GUI) or a display screen on a computer operated by user 160.

In some embodiments, an update record of the updated stored data may be stored in audit database 470. An update record may be a record or log of the updates to stored data 125 or a log of data change requests.

In some embodiments, a record of the updated stored data and a record of a query may be stored in audit database 470. Audit database 470 and the records stored therein may be used for data auditing (e.g. by auditor 215). Data auditing may include reviewing and analyzing data to ensure its accuracy, integrity, and compliance with predefined standards or regulations. Data auditing may include reviewing data records, unauthorized access, inconsistencies, or errors. In some embodiments, in response to an audit request, the update record or the query record may be accessed. An audit request may be a request to perform data auditing.

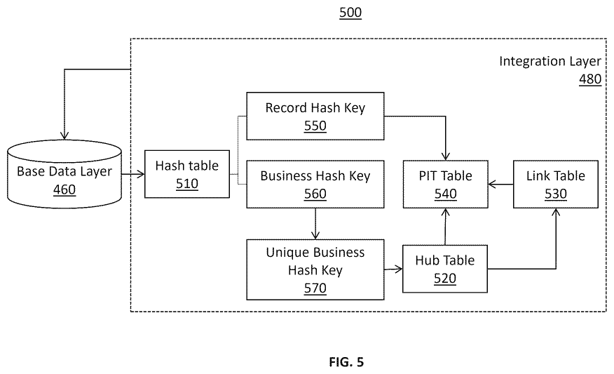

FIG. 5 illustrates an example system environment 500 for integration layer 480 of a technology analytics environment, consistent with disclosed embodiments. Integration layer may be a part of data warehouse 330 as shown in FIG. 4. In some embodiments, integration layer 480 may be separate from data warehouse 330. In some embodiments, any component used in integration layer 480 may reside separately from integration layer 480. For example, any component in integration layer 480 may reside in base data layer 460, data access platform 340, or temporary database 320. Components in integration layer 480 may include various tables (e.g. hash table 510, hub table 520, link table 530, or point-in-time (PIT) table 540) comprising references to data stored in base data layer 460. For each data record in base data layer 460, integration layer 480 may generate record hash key 550 and business hash key 560, both of which may be stored in hash table 510. Unique business hash key 570 (e.g. a newly identified business hash key) may be stored in hub table 520. A link between two or more hub tables may be stored in link table 530. A snapshot in time of hub table 520 or link table 530 with multiple record hash keys may be stored in PIT table 540.

In some embodiments, a hash key is used as a reference to a data record or business use. A hash key may be a value generated by a hash function that transforms input data into a fixed-size string of characters, such as numbers and letters. Hash keys may be deterministic because for a given input, a hash key should always be the same. Hash keys may be generated using an algorithm, including message digest method 5 (MD5), secure hash algorithm 1 (SHA-1), SHA-2, Windows™ New Technology local area network (LAN) Manager (NTLM), and LANMAN. A hash key may be used for data indexing, data retrieval, and ensuring data integrity, such as is the case with a surrogate hash key. A data index may be a reference used to identify the location in which the data is stored. By using hash keys, or surrogate hash keys, the location of content in databases can easily be found. The use of hash keys may enhance the efficiency and scalability of data storage and data retrieval operations. This may be particularly important in MPP systems, where the quantity of data stored can be large in comparison to other systems.

In some embodiments, record hash key 550 may be assigned to each data record. Record hash keys may be representative of each occurrence of at least one data record. As discussed previously, a data record may be a particular record of data elements that are related to one another. For example, a data record may be at least one row in a table (or a column). Record hash key 550 may be generated by integration layer 480 and assigned to an individual data record. Each record hash key 550 may represent an individual data record. For example, if base data layer 460 has a particular data record and a new data record for the same data types is added to the base table in base data layer 460, then a new record hash key may be generated for the new data record. So, each occurrence of a data record may result in each occurrence of record hash key 550. Record hash key 550 may also be generated (e.g. by integration layer 480) when stored data 125 is updated. As discussed previously, updating stored data 125 may include a data change request from data access platform 340.

In some embodiments, business hash key 560 may be assigned to each data record. Business hash key 560 may be a hash key representative of a business use or need. Business hash key 560 may be a hash key of a business key. A business key may be a unique identifier from a business need used to distinguish or identify a data record. Business keys may be based on real-world attributes useful in a business environment. For examples, business keys may include name, customer identification (ID), employee ID, username, Social Security number, email address, product code, international standard book number, etc. Consistent with some embodiments, each business hash key 560 may be representative of at least one predetermined use associated with the data record. A predetermined use may refer to data types, source type (e.g. source database 410), business needs, user 160, new user association with data, etc. In some embodiments, business hash key 560 may represent a column or row in stored data 125. As discussed earlier, a data record may be a row or column in stored data 125. In some embodiments, business hash key 560 may represent a data type. Business needs may include customer records, product records, employee records, etc. Business hash key 560 may also be generated (e.g. by integration layer 480) when stored data 125 is updated. As discussed previously, updating stored data 125 may include a data change request from data access platform 340 or new data records from source data 310.

In some embodiments, record hash key 550 and business hash key 560 may be computed before transmitting source data 310 to data warehouse 330. Record hash key 550 and business hash key 560 may be computed in integration layer 480 as shown in FIG. 3, or by temporary database 320 before reaching data warehouse 330. In some other embodiments, record hash key 550 and business hash key 560 may be computed after transmitting source data 310 to data warehouse 330. Record hash key 550 and business hash key 560 may be computed in integration layer 480 as shown in FIG. 3, or by base data layer 460 or some other component of data warehouse 330.

In some embodiments, hash table 510 may be generated. Hash table 510 may include record hash key 550 and business hash key 560. Hash table 510 may be a data structure that provides storage of hash keys for use in data retrieval (e.g. from base data layer 460). In some embodiments, record hash key 550 and business hash key 560 may be generated by hash table 510. In some embodiments, record hash key 550 and business hash key 560 may be stored in hash table 510. In some embodiments, hash table 510 may be updated with record hash key 550 associated with at least one data record and business hash key 560 associated with at least one predetermined use. In some embodiments, hash table 510 may use a hash function to compute an index for a data record into an array or table from which a desired value (e.g. data access platform 340) can be found within the table. In some embodiments, record hash key 550 or business hash key 560 may specify criteria to determine what partition of base data layer 460 to which to assign a data record. Record hash key 550 or business hash key 560 may be associated with a hash function that may be a function used to map data to a specific storage location. Criteria for where to stored the data record may be metrics or methods to distribute data, balance data, or optimize performance of storage or retrieval of data. Such criteria may be based on user information (e.g. user ID), business needs, source database 410, content of data (e.g. what information the data represents), etc. In such embodiments, temporary database 320 may transmit source data 310 to integration layer 480, which determines what and where to store data records in base data layer 460.

In some embodiments, hash table 510 may include at least one time point at which a data record was collected. A time point may be any time or date that acts as a snapshot for the collection of data. For example, when source data 310 is provided to data warehouse 330, a time point may be generated to record when the data record was collected. In some embodiments, the time point or hash table 510 may be stored in audit database 470.

In some embodiments, hub table 520 may be generated. Hub table 520 may include a new occurrence of business hash key 560. Hub table 520 may be a component that captures unique business keys, which may be stored as business hash keys 560. For example, hub table 520 may represent a project in a business. In this example, the business key may be a project number or identification, and business hash key 560 in hub table 520 may be the hash key of this business key. A new occurrence of business hash key 560 may occur when business hash key 560 is not stored in any hub table 520. For example, user 160 may input a query for new information in a new project that includes generation of a new business key and business hash key 560. In this example, a hub table 520 would be newly generated. In some embodiments, the hub table may be used to integrate and centralize the data (e.g. in integration layer 480).

In some embodiments, in response to a query, updated data may be accessed using hub table 510, business hash key 560, and record hash key 550. The updated data may be data that has had at least one new data record added, or data which has been modified by user 160. Hub table 510 may store business hash key 560. Business hash key 560 may point to hash table 510, which may store record hash key 550. Record hash key 550 may point to the location of a base table in base data layer 460 that contains data relevant to the query. In this way, the updated data may be accessed. In response to the query, the updated data may be modified.

In some embodiments, link table 530 may be generated. Link table 530 may include two or more business hash keys to establish a link between the two or more business hash keys. A link may be any connection between two or more entities. For example, a link may connect a first hub table that contains reference to data for an employee ID to a second hub table that contains references to data for a project. Link table 530 may be a table that links two or more hub tables. Link table 530 may be used to identify or record associations or relationships between data associated with two or more hub tables.

In some embodiments, link table 530 may include a unique association between two or more business hash keys. A unique association may be an association or relationship that is recorded only one time. For example, upon receiving a query from user 160 for assigning task in a project, link table 530 may record a first business hash key associated with an employee ID of user 160 and a second business hash key that contains a reference to the task for the project. In some embodiments, a data record may be updated with receiving a second query (e.g. change request) using link table 530 to identify stored data 125. The data record may be updated without updating hub table 520 and link table 530. For example, upon receiving a second query from user 160 changing some data for the task, link table 530 may not be updated, as the association is no longer unique. Instead, link table 530 may contain two or more business hash keys that may be used to find two or more record hash keys (e.g. in hash table 510), which may be used to find relevant data in base data layer 460. This process may provide a fast and scalable way to find stored data 125 upon receiving a query from data access platform 340.

In some embodiments, PIT table 540 may be generated. PIT table 540 may include a recorded time of the updated stored data associated with hub table 520. A recorded time may be a time point that acts as a snapshot of when an event occurred. A recorded time may include a time, data, etc. PIT table 540 may be a table that records copies or references of data along with a recorded time in which the record took place. PIT table 540 may be used to capture the state of stored data 125 at different points in time. In some embodiments, PIT table 540 may include record hash key 550 and a recorded time at which hub table 520 was generated.

In some embodiments, PIT table 540 may include record hash key 550 and a recorded time at which hub table 520 was accessed in response to a query. In some embodiments, PIT table 540 may include a recorded time of the association of two or more hub tables in link table 530. PIT table 540 may include a plurality of record hash keys along with a time stamp such that PIT table 540 may be used to determine what records may be in effect at a specific time point for records that may be related to one another. For example, a star-based join may occur when multiple hash tables may be associated with hub table 520. A star-based join may be a method to join multiple tables to one central table. The query may be associated with a data change request. In some embodiments, PIT table 540 may be updated. PIT table 540 may include record hash key 550 and a recorded time corresponding to the data change request. Therefore, PIT table 540 may provide a record of the data change request (or a data addition).

In some embodiments, PIT table 540 may be stored in audit database 470 and may be used for data auditing (e.g. by auditor 215). PIT table 540 may increase the efficiency of data auditing by providing rapid access to stored data 125 and all changes associated with the data that may have been done through data access platform 340. For example, PIT tables such as PIT table 540 may include records linking hub tables corresponding to user modification of data, hash keys corresponding to the modified data, and recorded times in which data was accessed or modified. For example, during data auditing PIT table 540 may be quickly identified and all records associated with PIT table 540 may be quickly located and provided to the data auditor for review.

One advantage of system environment 500 may be that through use of record hash key 550, business hash key 560, hash table 510, hub table 520, link table 530, or PIT table 540, a data change request from data access platform 340, or new data records from source data 310, may be added to base data layer 460 or provided to data access platform 340 without actually transferring data around during processing. For example, integration layer 480 does not need to move data around while processing or providing stored data 125 in base data layer 460. Rather, record hash key 550 and business hash key 560 may act as pointers or references to location of data records in stored data 125. The tables shown in FIG. 5 may act to speed up access to and modification of data in base data layer 460 by using record hash key 550 and business hash key 560 (e.g. unique business hash key 570 in hub table 520) to quickly locate only the relevant data records and directly add to, edit, or provide only those data records without moving around other data.

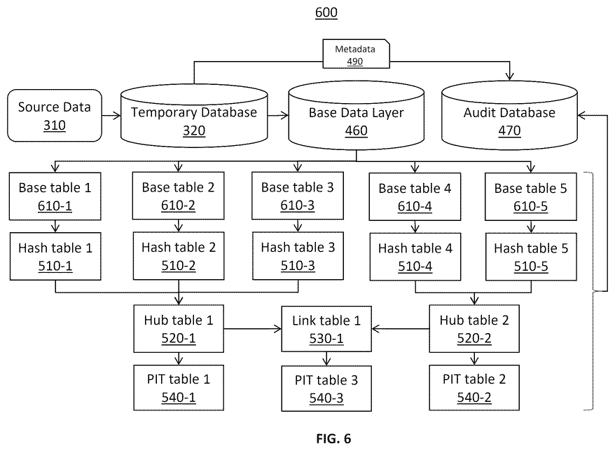

FIG. 6 illustrates an example process 600 for data flow in a technology analytics environment, consistent with disclosed embodiments. FIG. 6 incorporates elements of FIG. 4 and FIG. 5. A process is shown in which source data 310 is being stored in base data layer 460 while integration layer 480 (not shown in FIG. 6) may process the data starting with base tables 610-1, 610-2, 610-3, 610-4, and 610-5. Hash tables 510-1, 510-2, 510-3, 510-4, and 510-5 corresponding to the base tables are generated, each with the corresponding record hash key 550 and business hash key 560. Hash tables 510-1, 510-2, and 510-3 in combination are associated with hub table 520-1. Hash tables 510-4 and 510-5 in combination may be associated with hub table 520-2. Link table 530-1 may be associated with the combination of hub tables 520-1 and 520-2. PIT tables 540-1, 540-2, and 540-3 may be associated with hub table 520-1, hub table 520-2, and link table 530-1, respectively. FIG. 6 is meant to be only for explanatory purposes and is not meant to be limiting of any embodiments. Any number of base tables, hash tables, hub tables, link tables, and PIT tables may be used with the embodiments as described herein.

In some embodiments, any of source data 310, metadata 490, base tables (e.g. base tables 610-1, 610-2, 610-3, 610-4, and 610-5), hash tables (e.g. hash tables 510-1, 510-2, 510-3, 510-4, and 510-5), hub tables (e.g. hub tables 520-1 and 520-3), link tables (e.g. link table 530-1), or PIT tables (e.g. PIT tables 540-1, 540-2, and 540-3) may be stored in audit database 470. By retaining records of each of these tables along with source data 310 or metadata 490 of source data 310, audit database 470 can facilitate efficient and accurate data auditing with scalability.

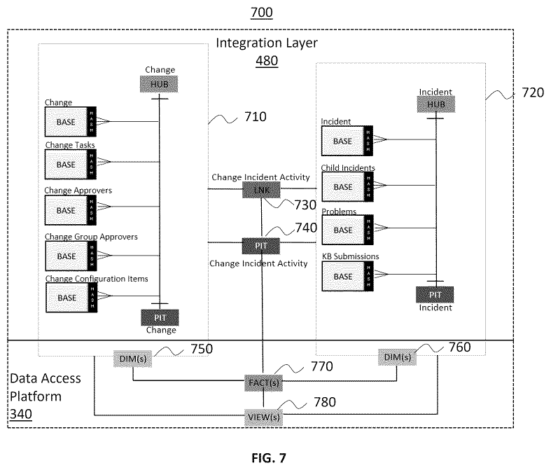

FIG. 7 illustrates example process 700 in a technology analytics environment, consistent with disclosed embodiments. FIG. 7 shows change process 710 and incident process 720. Together, information affiliated with change process 710 and incident process 720 may be stored in change incident link table 730. Change incident PIT table 740 may record a snapshot of change incident link table 730. In data access platform 340, data associated with integration layer 480 may be visualized and displayed (i.e. for user 160). Change process 710 may allow for dimension view 750, and incident process 720 may allow for dimension view 760. Dimension view 750, dimension view 760, and change incident PIT table 740 may be used in fact view 770. Change process 710, incident process 720, and fact view 770 may be used in flattened view 780.

Change process 710 may be when a planned modification or update to data or data systems may occur. A planned modification may be an expected change by a business or a data change request or query by user 160. Change process 710 may include a change hub table, a change PIT table, and various base tables and hash tables. For example, as shown in FIG. 7, base tables and hash tables may be related to changes, change tasks, change approvers, change groups approvers, change configuration items, etc.

Incident process 720 may be when an unplanned disruption or problem occurs. Unplanned disruptions may include system outages, data corruption (e.g. errors in data), performance degradation related to slower processing, data breaches associated with unauthorized access to stored data 125, etc. Incident process 720 may include an incident hub table, an incident PIT table, and various base tables and hash tables. For example, as shown in FIG. 7, base tables and hash tables may be related to incidents, child incidents, problems, knowledgebase (KB) submission, etc.

In some embodiments, a change may be associated with an incident, and a flattened view may be provided in data access platform 340. For example, when attempting to make a change to data in base data layer 460 (e.g. change process 710), a problem may occur, resulting in incident process 720, which is linked through change incident link table 730 to change process 710. This link may be displayed to user 160 in data access platform 340.

In data access platform 340, various forms of visualizing data are enabled. Data access platform 340 may act as a consumption layer for data warehouse 330. A consumption layer may be the part of a data system where data may be accessed, queried, and utilized by end users (e.g. user 160). Data may be visualized using dimension views such as dimension view 750 and dimension view 760. Dimension views may provide context or background information (e.g. metadata 490) related to data. A dimension view may be a way to simplify and view dimensional data or structured data. For example, a dimension view may be a summary in a table of data types and other information pertinent to characterize data. For example, dimensional data may include descriptive or categorical data such as product information, customer details, geographic locations, time periods, etc. Data may also be visualized using fact views such as fact view 770. Fact views may include fact tables which may present quantitative data (numerical data) in simplified and user-friendly way (e.g. easier to query and analyze the data). Data may also be visualized using flattened views such as flattened view 780. Flattened views may take dimensional views or fact views in any combination and simplify them, often organizing the flattened and dimensional views into a single table. For example, flattened view 780 may combine dimension view 750, dimension view 760, and fact view 770 to show a summary of activity associated with change incident link table 730.

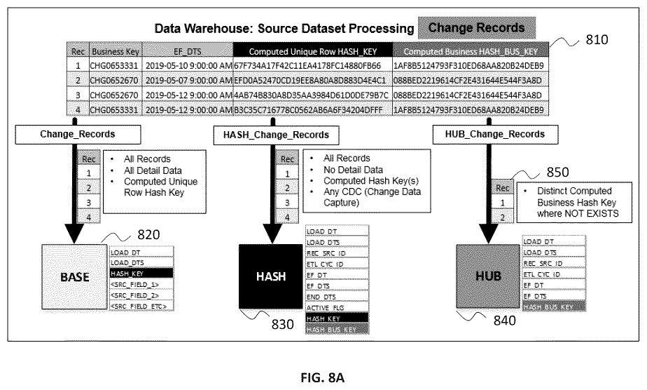

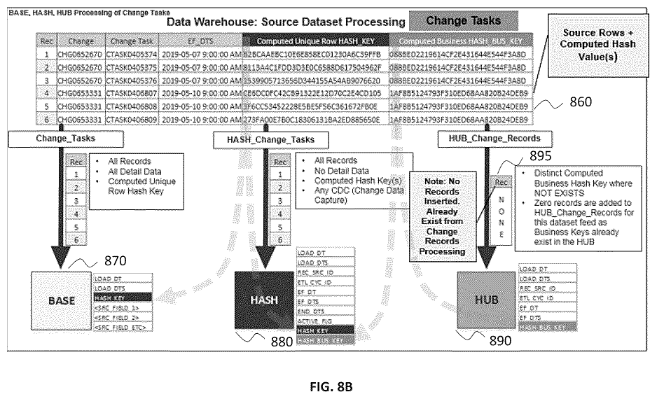

FIG. 8A illustrates an example of changing records in a technology analytics environment, consistent with disclosed embodiments. A change record may be any record for which a request for change may occur (e.g. a data change request). A change may be any modification to any data. For example, a request for a change may be when a user requests to change a username associated with a project. Such a change may result in a modification of the data record (e.g. if a user has the appropriate permissions) and generation of a change record. As shown in FIG. 8A, a record change table 810 is presented that shows a list of rows containing data records, business keys recorded times, and computed record hash keys and business hash keys corresponding to the data records. Record change table 810 may be flattened, fact, or dimension view of hash keys for data records. Record change table 810 may represent data records stored in base tables like base table 820. Hash keys in record change table 810 may be stored in hash tables like hash table 830. Unique business hash keys (e.g. unique business hash key 570) in record change table 810 may be stored in hub tables like hub table 840. In this example, only unique data records 850 are included in hub table 840. Unique data records 820 may be records which represent the unique business hash keys.

FIG. 8B illustrates an example of changing tasks in a technology analytics environment, consistent with disclosed embodiments. Changing tasks may be any tasks for which a request for a change was made, e.g. by data access platform 340. FIG. 8B may correspond to change records that were shown in FIG. 8A. Task change table 860 may be flattened, fact, or dimension view of hash keys for data records. Task change table 860 may represent data records stored in base tables like base table 870. Hash keys in task change table 860 may be stored in hash tables like hash table 880. Unique business hash keys (e.g. unique business hash key 570) in task change table 860 may be stored in hub tables like hub table 690. In this example, no unique data records are present (i.e. null records 895). Since null records 895 is empty, no business hash keys may be added to hub table 890.

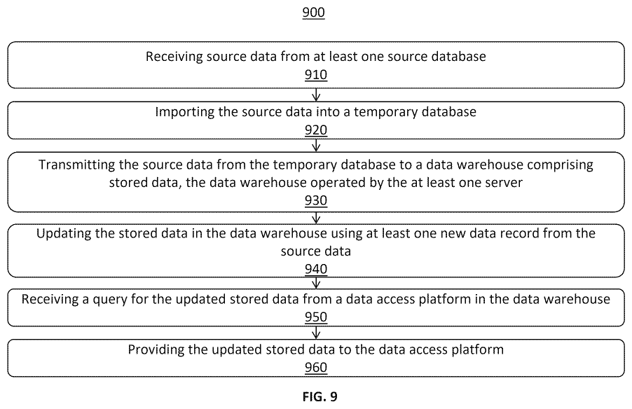

FIG. 9 illustrates an exemplary process 900 for updating stored data, consistent with disclosed embodiments. The steps of method 900 may use any of the embodiments of FIGS. 3-5 or any of the examples of FIGS. 6-8.

In step 910 of FIG. 9, process 900 may include receiving source data from at least one source database. The source data may be source data 310, as shown in FIGS. 3, 4, and 6. The source database may be source database 410, as shown in FIG. 4. The source database may be third-party databases, or databases stored or accessed by a server (e.g. server 420) directly.

In step 920 of FIG. 9, process 900 may include importing the source data into a temporary database. The temporary database may be temporary database 320, as shown in FIGS. 3, 4, and 6. The temporary database may be external to the server, as shown in FIG. 4, or the temporary database may be internal to the server. In the latter case, the source data may be fed directly into the server.

In step 930 of FIG. 9, process 900 may include transmitting the source data from the temporary database to a data warehouse comprising stored data. The data warehouse may be operated by at least one server (e.g. server 420). The data warehouse may be data warehouse 330, as shown in FIGS. 3 and 4. The stored data may be stored data 125, as shown in FIGS. 1-3. The stored data may be in various databases. For example, the stored data may include structured data stored as cells in columns or rows of a table. The data warehouse may include various layers for data flow, including a base data layer where the stored data may be stored, an integration layer, where data may be processed, and a consumption layer, which may include a data access platform, which may allow a user (e.g. user 160, as shown in FIGS. 1, 2, and 4) to access or modify data. Integration layer may be integration layer 480, as shown in FIGS. 4, 5, and 7.

In step 940 of FIG. 9, process 900 may include updating the stored data in the data warehouse using at least one new data record from the source data. A new data record may include any new data from the source data that may be added as a record in the stored data in a base data layer (e.g. base data layer 460, as shown in FIGS. 4-6). For example, a row of a table from the source data may be a new data record to be added to at least one base table in the base data layer. Updating stored data may include adding or modifying the stored data. Updating stored data may include the use of the base data layer, a record hash key, a business hash key, a unique business hash key, a hash table, a hub table, a link table, or a PIT table, in any combination. For example, updating stored data may involve embodiments depicted in FIG. 5.

In step 950 of FIG. 9, process 900 may include receiving a query for the updated stored data from a data access platform in the data warehouse. The data access platform may be data access platform 340, as shown in FIGS. 3, 4, and 7. A query may originate from a user when requesting access to or modification of existing data in the stored data.

In step 960 of FIG. 9, process 900 may include providing the updated stored data to the data access platform. Updated stored data may be provided by visualization of data in the consumption layer of the data warehouse.

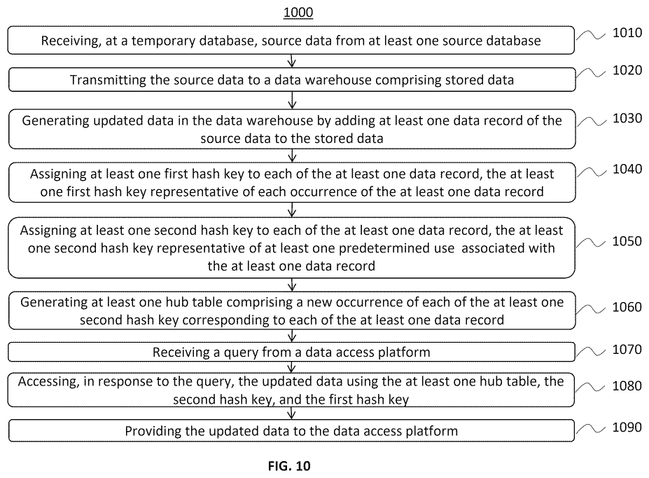

FIG. 10 illustrates an exemplary process 1000 for providing the updated data to a data access platform, consistent with disclosed embodiments. The steps of method 1000 may use any of the embodiments of FIGS. 3-5 or any of the examples of FIGS. 6-8.

In step 1010 of FIG. 10, process 1000 may include receiving, at a temporary database, source data from at least one source database.

In step 1020 of FIG. 10, process 1000 may include transmitting the source data to a data warehouse comprising stored data.

In step 1030 of FIG. 10, process 1000 may include generating updated data in the data warehouse by adding at least one data record of the source data to the stored data.

In step 1040 of FIG. 10, process 1000 may include assigning at least one first hash key to each of the at least one data record, the at least one first hash key representative of each occurrence of the at least one data record. The at least one first hash key may be record hash key 550, as shown in FIG. 5. For each occurrence of a data record from the source data or data change request from a data access platform, the first hash key may be computed at the integration layer and assigned. The first hash key may be stored in a hash table, a link table, or a PIT table (e.g. PIT table 540, as shown in FIGS. 5 and 6, or change incident activity PIT table 740, as shown in FIG. 7). Auditability of the data may be improved by maintaining a record of all data records or data record changes.

In step 1050 of FIG. 10, process 1000 may include assigning at least one second hash key to each of the at least one data record, the at least one second hash key representative of at least one predetermined use associated with the at least one data record. The at least one second hash key may be business hash key 560, as shown in FIG. 5. A predetermined use may be affiliated with a business need or user need. The second hash key may be used to categorize data records according to what the business needs for the data records may be. For example, a project code will always produce the same business hash key. Like the first hash key, the second hash key may be deterministic, in that both keys may produce the same output for the same input. Both the first and second hash keys may help speed up access to the stored data by providing location and access of data in the stored data without actually needing to move the data around.

In step 1060 of FIG. 10, process 1000 may include generating at least one hub table comprising a new occurrence of each of the at least one second hash key corresponding to each of the at least one data record. The at least one hub table may be hub table 520, as shown in FIGS. 5 and 6, hub table 840, as shown in FIG. 8A, or hub table 890, as shown in FIG. 8B. The hub table may only include a unique business hash key (e.g. unique business hash key 570, as shown in FIG. 5) corresponding to each of the at least one data record. For example, the hub table may contain reference to a particular project associated with a business need. In this case, additional hub tables for the same project would not be needed. Having fewer hub tables (e.g. only ones according to unique business hash keys) may help to improve processing performance or efficiency.

In step 1070 of FIG. 10, process 1000 may include receiving a query from a data access platform.

In step 1080 of FIG. 10, process 1000 may include accessing, in response to the query, the updated data using the at least one hub table, the at least one second hash key, and the at least one first hash key. For example, a query may be associated with a business need that corresponds to the hub table that contains the second hash key. A hash table may include the second hash key and the first hash key (e.g. hash table 510, as shown in FIGS. 5 and 6, hash table 830, as shown in FIG. 8A, or hash table 880, as shown in FIG. 8B. The first hash key may be used to locate a data record in the stored data relevant to the query.

In step 1090 of FIG. 10, process 1000 may include providing the updated data to the data access platform. Updated data may be provided by visualization of the updated data in the consumption layer of the data warehouse.

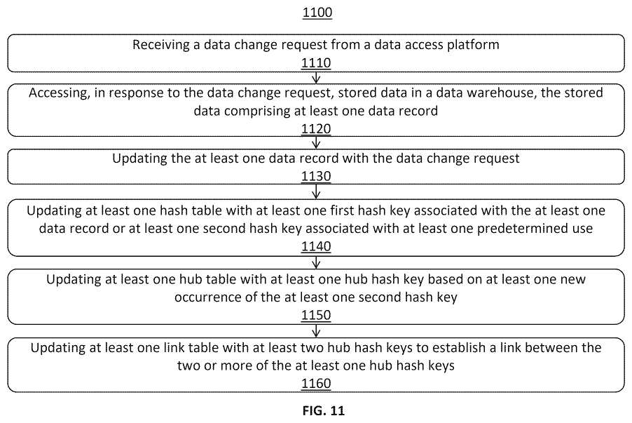

FIG. 11 illustrates an exemplary process 1100 for updating tables, consistent with disclosed embodiments.

In step 1110 of FIG. 11, process 1100 may include receiving a data change request from a data access platform. A data change request may be a query from a user.

In step 1120 of FIG. 11, process 1100 may include accessing, in response to the data change request, stored data in a data warehouse, the stored data comprising at least one data record. Accessing the stored data may include using a first hash key, a second hash key, a hash table, a hub table, a link table, or a PIT table to locate data records in the stored data.

In step 1130 of FIG. 11, process 1100 may include updating the at least one data record with the data change request. Updating a data record may include adding to or modifying the stored data. For example, base tables in the base data layer may be modified in response to a data change request.

In step 1140 of FIG. 11, process 1100 may include updating at least one hash table with at least one first hash key associated with the at least one data record or at least one second hash key associated with at least one predetermined use. Updating the first hash key or the second hash key may include adding a new hash table, adding a first hash key or second hash key to the hash table, or modifying the first hash key or the second hash key in the hash table.

In step 1150 of FIG. 11, process 1100 may include updating at least one hub table with at least one hub hash key based on at least one new occurrence of the at least one second hash key. Updating the hub table may include adding a new hub table, or adding a second hash key to or modifying a second hash key in the hub table.

In step 1160 of FIG. 11, process 1100 may include updating a link table (e.g. link table 530, as shown in FIGS. 5 and 6, or change incident activity link table 730, as shown in FIG. 7) with at least two second hash keys to establish a link between the second hash keys. A link may indicate some business association between two hub tables or business needs or uses.

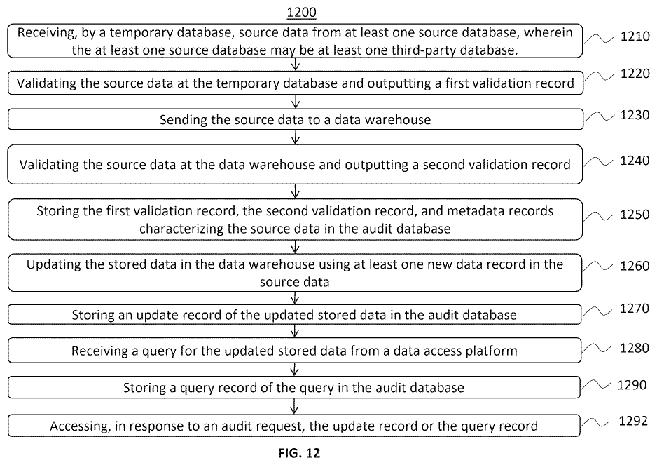

FIG. 12 illustrates exemplary process 1200 for maintaining an audit database (e.g. audit database 470, as shown in FIGS. 4 and 6), consistent with disclosed embodiments.

In step 1210 of FIG. 12, process 1200 may include receiving, by a temporary database, source data from at least one source database. The at least one source database may be at least one third-party database.

In step 1220 of FIG. 12, process 1200 may include validating the source data at the temporary database and outputting a first validation record. A validation record may be used for maintaining a track of records for the source data including any results from validation. For example, if any errors are detected during validation, the validation record will show the errors.

In step 1230 of FIG. 12, process 1200 may include sending the source data to a data warehouse.

In step 1240 of FIG. 12, process 1200 may include validating the source data at the data warehouse and outputting a second validation record. Having a second validation record may further help with data auditing (e.g. by auditor 215, as shown in FIG. 2).

In step 1250 of FIG. 12, process 1200 may include storing the first validation record, the second validation record, and metadata records characterizing the source data in the audit database. Metadata records (e.g. metadata 490, as shown in FIGS. 4 and 6) may be used as a descriptive reference to the stored data, the source data, or the source database. Metadata records may also include a record of any data record changes.

In step 1260 of FIG. 12, process 1200 may include updating the stored data in the data warehouse using at least one new data record in the source data.

In step 1270 of FIG. 12, process 1200 may include storing an update record of the updated stored data in the audit database. An update record may provide a record of all changes, including data change requests and which users may the data change request.

In step 1280 of FIG. 12, process 1200 may include receiving a query for the updated stored data from a data access platform.

In step 1290 of FIG. 12, process 1200 may include storing a query record of the query in the audit database. A query record may be a record of all queries done by at least one user.

In step 1292 of FIG. 12, process 1200 may include accessing, in response to an audit request, the update record or the query record. An audit request may be provided through the data warehouse. For example, an audit request may be done for checking the data integrity or for checking on changes done to data by different users.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1-23. (canceled)

24. A method for changing records in a technology analytics environment using at least one processor of at least one server, the method comprising:
receiving a data change request from a data access platform;
obtaining, in response to the data change request, new data from a data warehouse, the new data comprising at least one data record;
updating at least one base table with new data and at least one first hash key associated with the new data;
updating at least one hash table with the at least one first hash key and at least one second hash key associated with at least one predetermined use, wherein the at least one hash table is distinct from the at least one base table;
updating at least one hub table with at least one new second hash key, the at least one new second hash key corresponding to at least one new occurrence of the at least one second hash key; and
updating at least one link table with at least two hub hash tables of the at least one hash table to establish a link between the at least two hub hash tables.

25. The method of claim 24, further comprising updating a point in time table comprising at least one first hash key and a recorded time corresponding to the data change request.

26. The method of claim 24, wherein the at least one link table comprises a unique association between two or more of the at least one hub hash keys.

27. The method of claim 24, further comprising updating the at least one data record with a second change request using the at least one link table to identify the stored data without updating the at least one hub table and the at least one link table.

28. A system for changing records in a technology analytics environment, the system comprising at least one processor of at least one server, the at least one processor configured to:
receive a data change request from a data access platform;
obtain, in response to the data change request, new data from a data warehouse, the new data comprising at least one data record;
update at least one base table with the new data and at least one first hash key associated with the new data;
update at least one hash table with the at least one first hash key and at least one second hash key associated with at least one predetermined use, wherein the at least one hash table is distinct from the at least one base table;
update at least one hub table with at least one new second hash key, the at least one new second hash key corresponding to at least one new occurrence of the at least one second hash key; and
update at least one link table with at least two hub hash tables of the at least one hash table to establish a link between the at least two hub hash tables.

29-33. (canceled)

34. The system of claim 28, wherein the at least one link table comprises a unique association between two or more of the at least one hub hash tables.

35. The system of claim 28, wherein the at least one base table comprises the at least one data record and the at least one first hash key, and the at least one hash table comprises the at least one first hash key and the at least one second hash key.

36. The method of claim 24, further comprising:
obtaining from third party sources, the new data; and
storing the new data in the data warehouse.

37. The method of claim 24, wherein updating the at least one hash table comprises inserting a new entry for each of the at least one data record.

38. The method of claim 24, wherein updating the at least one link table comprises updating a unique combination of the at least two hub hash tables.

39. The method of claim 24, wherein receiving the data change request triggers a data ingestion process to retrieve the at least one data record from at least one source database into the data warehouse.

40. The method of claim 24, further comprising:
generating a dimension view in the data access platform, the dimension view including a combination of metadata associated with the updated data; and
displaying the dimension view via a user interface on the data access platform.

41. The method of claim 24, further comprising:
generating a fact view in the data access platform, the fact view including a quantitative data derived from the updated data; and
displaying the fact view via a user interface on the data access platform.

42. The method of claim 24, further comprising:
generating a flattened view in the data access platform, the flattened view including a combination of dimension and fact views derived from the updated data; and
displaying the flattened view via a user interface on the data access platform.

43. The system of claim 28, wherein the at least one hash table corresponds to the at least one base table in a 1:1 relationship, such that a first base table of the at least one base table comprises a first hash key of the at least one first hash key and a first hash table comprises the first hash key.

44. The method of claim 24, wherein updating the at least one base table comprises inserting the at least one data record.

45. The method of claim 24, wherein updating the at least one base table comprises generating at least one new base table comprising the at least one data record.

46. The method of claim 24, wherein updating the at least one base table comprises replacing the at least one base table with at least one new base table comprising the at least one data record.

47. The method of claim 24, wherein updating the at least one hash table comprises replacing the at one hash table with at least one new hash table comprising the at least one data record.

48. The method of claim 24, further comprising loading the at least one base table, the at least on hash table, and the at least one hub table in parallel.
